(19) United States
(12) Patent Application Publication
(10) Pub. No.: US 2013/0237199 A1
(43) Pub. Date: Sep. 12, 2013

(54) Systems and Methods for Personalizing the surrounding environment of a user with a personal computing device

(71) Applicants: Lori Djavaherian, San Clemente, CA (US); Forrest Djavaherian, San Clemente, CA (US)

(72) Inventors: Lori Djavaherian, San Clemente, CA (US); Forrest Djavaherian, San Clemente, CA (US)

(21) Appl. No.: 13/416,524

(22) Filed: Mar. 9, 2012

(51) Int. Cl. H04W 4/02

(52) U.S. Cl. 455/418

(57) ABSTRACT

The field of the invention relates to wireless-based applications, and more particularly to systems and methods for personalizing the atmospherics of a user with a personal computing device. In one embodiment, a computer-based system for personalizing one or more parameters of a surrounding environment based on a user identification associated with a personal computing device includes a personalization engine subsystem coupled to a computer network having a local area defined by a distance from the personalization engine subsystem, wherein the personalization engine subsystem is configured to identify when the personal computing device is within the local area and to obtain the user identification associated with the personal computing device. The system further includes a personalization database and one or more parameter controllers communicatively coupled to the personalization engine subsystem to enable personalization of the surrounding environment.

### FIELD OF THE INVENTION

The field of the invention relates to wireless-based applications, and more particularly to systems and methods for personalizing the surrounding environment of a user with a personal computing device.

### BACKGROUND OF THE INVENTION

Individuals commonly carry network based personal computing devices, such as cell phones and smart phones, on or near their person. Such devices may use a variety of communication technologies for sending and/or receiving signals from other electronic devices. Examples of such technologies can include, among other things, 802.11 or “WiFi”, Bluetooth, near field communication (or NFC), cellular communication protocols, infrared technologies, or global positioning technologies (GPS). Using these or other communication technologies, such electronic devices can be configured to communicate with and recognized by another electronic device when both devices are in physical proximity.

Communications of this sort between electronic devices can be utilized to generate unique responses to the presence of a particular electronic device. When an electronic device has been set to recognize the presence of another electronic device, a user can set or pre-program a wide variety of responses to such presence. Such responses may be automated to occur without further user input or action.

Personalized cell phone “ring tones” have become popular in recent years. Customizable doorbell chimes also have been available, but generally do not permit personalization in response to the presence of particular other devices or individuals. For instance, such a device is described here. http://www.wired.com/geekdad/2011/01/customize-your-doorbell-ringtone-with-honeywell/. One personalized doorbell chime has been described at http://www.popsci.com/dingtones, involving a stationary fingerprint scanner. No existing device has been located using wireless communication technologies such as those identified herein or any of the other improved or automated approaches described.

A limited security implementation involving identification of a particular cell phone is described in U.S. Pat. No. 8,040,216. The approach described there involves the use of caller ID or similar technologies that require different steps and communications than the approach described.

Also, in U.S. Pat. No. 7,548,875, an approach to wireless delivery of audio content is described, including a passing reference to doorbells.

None of these approaches describe personalizing a user's atmospherics based on the identification of the user's personal computing device. Such a system would be desirable.

### SUMMARY OF THE INVENTION

The field of the invention relates to wireless-based applications, and more particularly to systems and methods for personalizing the atmospherics of a user with a personal computing device. In one embodiment, a computer-based system for personalizing one or more parameters of a surrounding environment based on a user identification associated with a personal computing device includes a personalization engine subsystem coupled to a computer network having a local area defined by a distance from the personalization engine subsystem, wherein the personalization engine subsystem is configured to identify when the personal computing device is within the local area and to obtain the user identification associated with the personal computing device. The system further includes a personalization database communicatively coupled to the personalization engine subsystem that stores one or more profiles, each electronically associated with a user identification and data that defines one or more parameters of the surrounding environment. The system further includes one or more parameter controllers communicatively coupled to the personalization engine subsystem, wherein the personalization engine subsystem is further configured to query the personalization database for the profile associated with the obtained user identification, and transmit one or more parameters to the one or more parameter controllers based on the data associated with the profile.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is an exemplary diagram of a personalization system in accordance with a preferred embodiment of the present invention.

FIG. 2 is an exemplary diagram of a personalization system in accordance with another preferred embodiment of the present invention.

FIG. 3 is an exemplary diagram of a personalization server in accordance with a preferred embodiment of the present invention.

FIG. 4 is an exemplary diagram of a personalization process in accordance with a preferred embodiment of the present invention.

### DETAILED DESCRIPTION OF THE PREFERRED EMBODIMENTS

### Preferred Systems

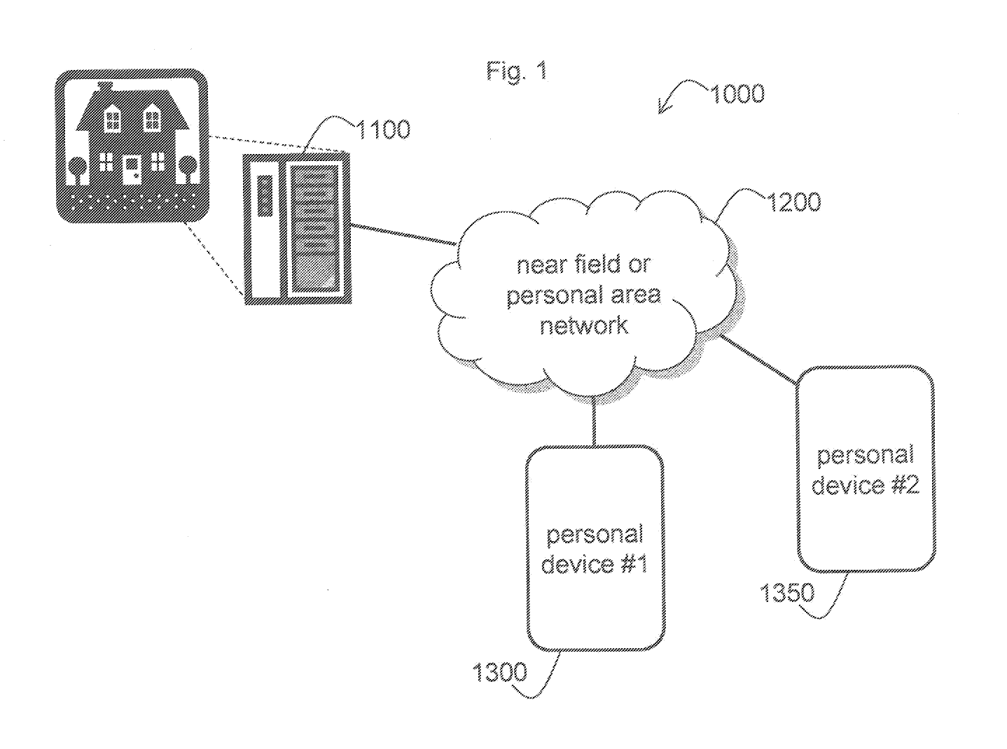

Turning to FIG. 1, a system 1000 for personalizing the atmospherics or surrounding environment of a user in accordance with a preferred embodiment of the present invention is shown. The personalization system 1000 generally includes a personalization server 1100 associated with a targeted area, such as a residential house, and one or more personal computing devices 1300/1350 all operatively coupled to a near field or personal area network 1200, such as Bluetooth, near field communication (“NFC”), wifi/802.11, or infrared technologies known in the art.

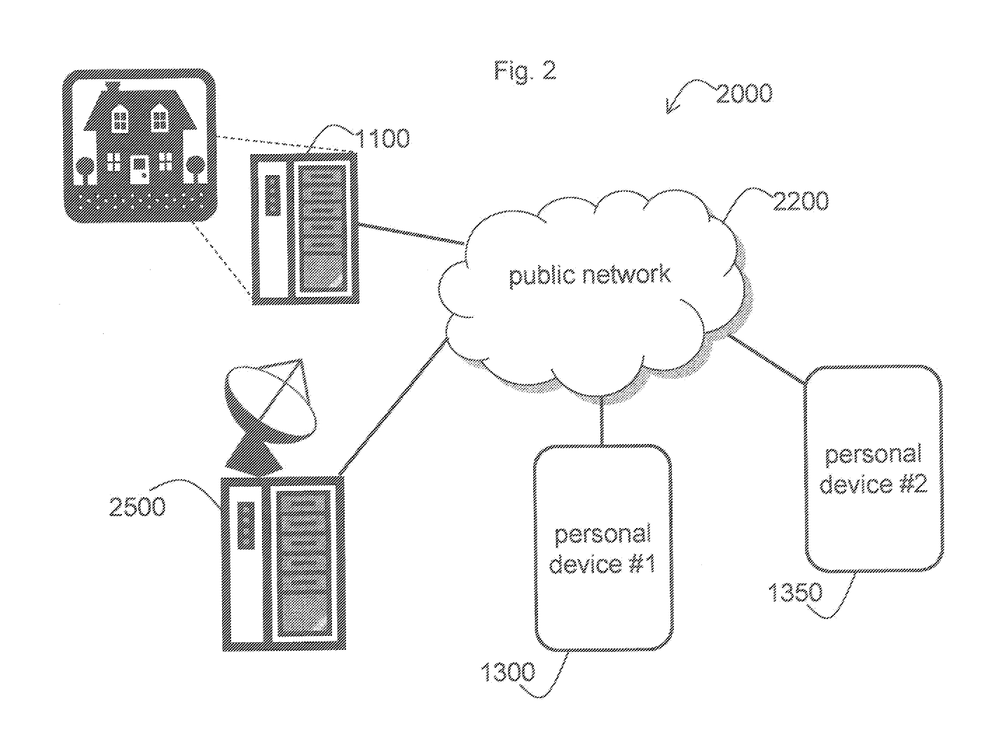

Turning to FIG. 2, an alternative system 2000 for personalizing the atmospherics or surrounding environment for a user in accordance with a preferred embodiment of the present invention is shown. The personalization system 2000 also includes a personalization server 1100 and one or more personal computing devices 1300/1350, but these component can be operatively coupled to the Internet or cellular-based wireless network 2200 and are operatively coupled to a location identification server 2500 (coupled to a global positioning system “GPS”).

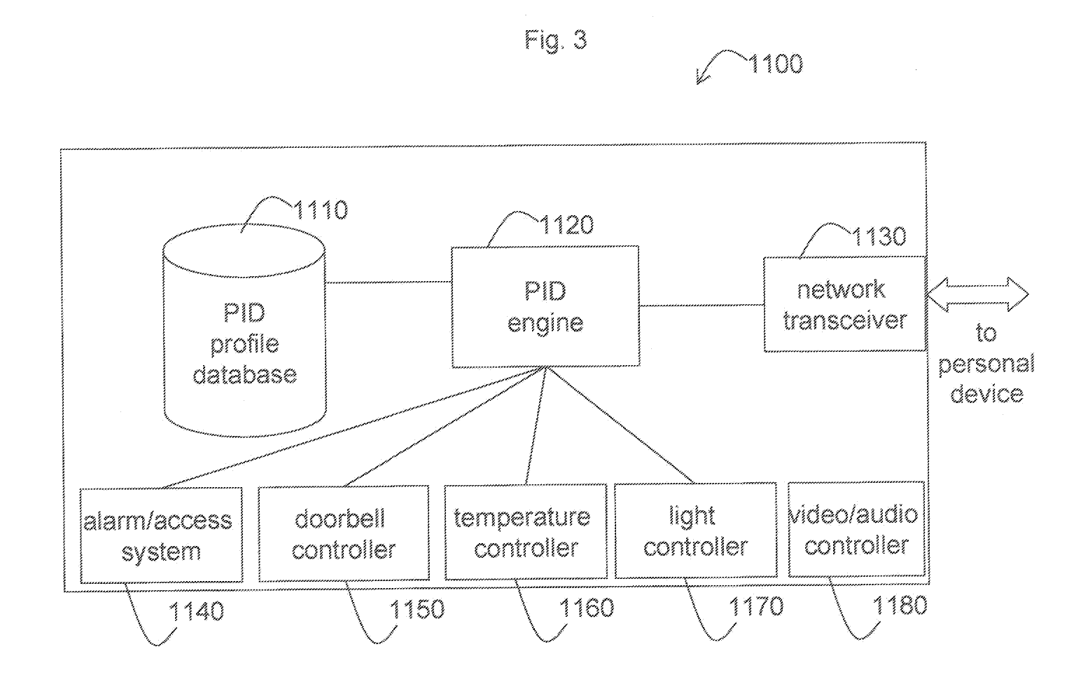

Turning to FIG. 3, a diagram of a preferred personalization server 1100 is shown. The personalization server 1100 includes a processor and memory and a number of software components. As mentioned above, the personalization server 1100 is associated with a targeted area, such as a residential building, having an atmosphere or surrounding environment defined by one or more parameters. Such parameters can include light, audio, video, security, temperature and doorbell tone.

Each one of these parameters can be defined by a computer controller known in the art. For example, access and alarm system for the residential building can be controlled by an alarm/access system 1140 known in the art. The doorbell chime can be controlled by a doorbell chime controller 1150 known in the art. The temperature of the building can be controlled by a temperature controller 1160 known in the art. The lighting in the building can be controlled by a light controller 1170 known in the art. The audio and/or video playing within the building can be controlled by an audio/video controller 1180 known in the art.

Different people have different preferences in parameters. For example, some may prefer dimly lit rooms as opposed to bright rooms, and certain individuals should be entitled to unfettered access to the building, such as the owner. These preferences can be stored as data in a database 1110 associated with the user's personal identification. This personal identification can be an existing identification associated with the user's personal computing device 1300/1350. For example, each iPhone generally includes a unique identifier. Users can also establish their own personal identifier (“PID”), such as a unique number or simply their name. Any value that can be identified with a particular user can be used as a PID, and this PID for a particular user can be used to store the user's parameter preferences in the database 1110. The server 1100 further includes a PID engine 1120 that queries the database 1110 for the preferences associated with the PID and transmits those preferences to the respective controllers 1140/1150/1160/1170/1180 to set the parameters accordingly. In the alternative, one or more of these controllers 1140/1150/1160/1170/1180 can be located physically outside of the server 1100 and can be operatively coupled to the server 1100 by a computer network, e.g., 1200/2200.

The PID engine 1120 is further coupled to a network transceiver 1130. The network transceiver 1130 is operatively coupled to a personal area or near field communications network 1200 and/or a public network 2200 coupled to a GPS system 2500. This enables the server 1100 to detect the presence of a user's personal computing device 1300/1350 within a certain distance. For example, in a Bluetooth network, a device can be detected within approximately 100 meters. In the case of a connection to a public network and a GPS system 2500, the distance threshold can vary based on the administrator's preference.

The PID engine 1120 is configured to detect the presence of a personal computing device 1300/1350 within the targeted area and obtain a PID from the personal computing device 1300/1350, if any.

### Preferred Processes

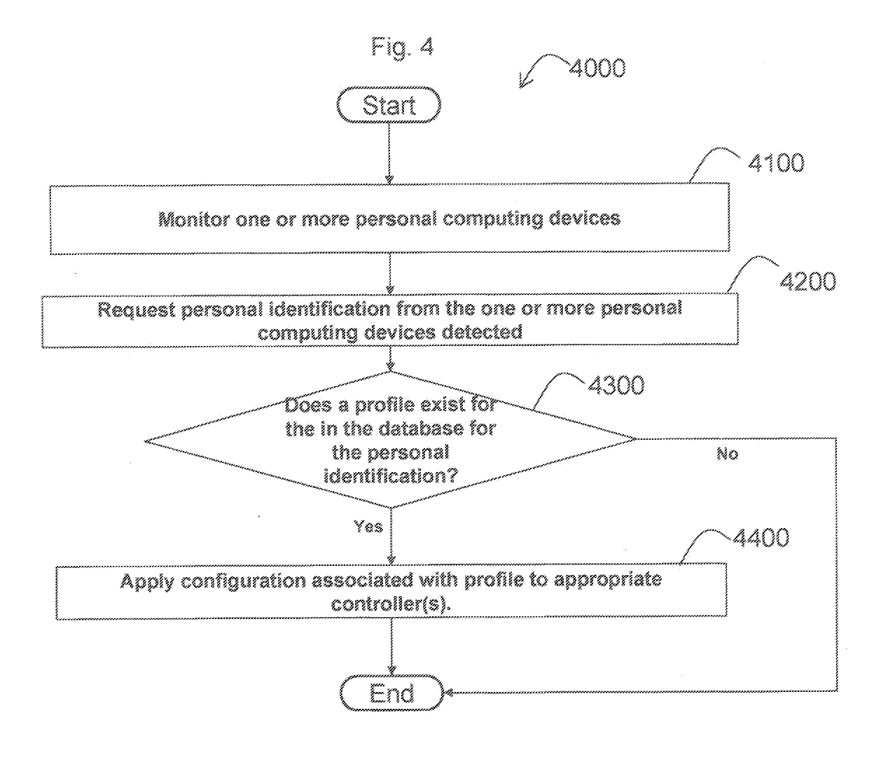

Turning to FIG. 4, a process 4000 of the systems 1000/2000 is described. The server system 1100 is configured to monitor the presence of one or more personal computing device 1300/1350 (Action Block 4100) within a targeted area. When a personal computing device 1300/1350 is detected, e.g., if it's within a 100 meters of the server system 1100, then the PID engine 1120 attempts to obtain a PID from the detected personal computing device 1300/1350 (Action Block 4200). If a PID is obtained, then the PID engine 1120 checks the PID profile database 1110 to determine whether a profile exists (Decision Block 4300). If so, then the parameters are obtained from the database 1110 and applied to the respective controllers 1140/1150/1160/1170/1180 (Action Block 4400).

The algorithm for detection of a personal computing device 1300/1350 is not limited to simply presence of the device. For instance, certain parameters may be set based on whether a multiplicity of certain personal computing devices 1300/1350 all are present. Or different responses might be elicited based on other, additional conditions that are set by the user or administrator, such as the time of day.

These systems and processes described above enable the surrounding environment to be configured based on a user's arrival. For instance, a door or other device may be unlocked or opened, granting the user access. Or the user's presence may be announced in some fashion. For example, a doorbell or similar device may be set to play a personalized chime or personalized music when that user's presence is detected. Or a second device, such as the homeowner's cellphone, could play a tone or other announcement of the proximity of the first device (and thus its owner). Various other responses to the owner's perceived presence could be implemented, for purposes such as security, announcement, electricity savings, screening, access, accommodation of particular needs or issues of the user (e.g., health, allergies), video, compiling or publishing attendance lists, or numerous other purposes.

In one implementation, a home owner could set an electronic system to recognize the cell phone of various friends or acquaintances, and to play a different sound in response to each. One might imagine a holiday party, where different variations of holiday music are personalized to the arrival each attendee.

In another implementation, a door security system, or garage door, could be set to unlock and allow access to a home or office in response to the presence of certain portable electronic devices but not others. Such information regarding attendance might be maintained online or shared via social networking sites. Certain devices could be set to cause such a response only at specified times or dates, or only a specified number of times (e.g., a certain door could be opened by a certain person only once a day).

In another implementation, lighting could be programmed to turn on or off in response to the presence of a certain portable electronic device (or the presence of any of a multiplicity of electronic devices). In addition to the convenience of such automatic response, the implementation could reduce electric expenses. A similar approach could be used with heating and cooling systems as described above.

In another implementation, a portable device, such as a cellphone, could be set to automatically take certain actions when in the proximity (as determined via GPS technology or otherwise) of another device, such as sending that device a text message indicating its nearness (or a message indicating that it is no longer near). Such an implementation could be used for instance, for social purposes—such as informing friends of a person's arrival at a destination.

A wide variety of other reactions to the presence of known or unknown portable electronic devices may be effected at the discretion of the user. A wide variety of portable devices may be involved. Smart phones are used as examples in a number of the circumstances described above, but other electronic devices (whether carried, worn or implanted) may be used.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions described herein is merely illustrative, and the invention may appropriately be performed using different or additional process actions, or a different combination or ordering of process actions. Additionally and obviously, features may be added or subtracted as desired. Accordingly, the invention is not to be restricted except in light of the attached claims and their equivalents.

1-10. (canceled)

11. A computer-based system for personalizing a doorbell tone based on a user identification associated with a personal computing device, comprising:
a doorbell tone controller coupled to a computer network having a local area defined by a distance from the doorbell tone controller, wherein the doorbell tone controller is configured to identify when the personal computing device is within the local area and to obtain the user identification associated with the personal computing device;
a doorbell tone database communicatively coupled to doorbell tone controller that stores one or more profiles, each electronically associated with a user identification and a specific doorbell tone;
wherein the doorbell tone controller is further configured to query the doorbell tone database for the profile associated with the identified personal computing device and to set the doorbell tone to the specific doorbell tone associated with the queried profile of the identified personal computing device.
